(19) United States
(12) Patent Application Publication
(10) Pub. No.: US 2010/0106837 A1
(43) Pub. Date: Apr. 29, 2010

(54) INFORMATION PROCESSING APPARATUS AND METHOD FOR PROCESSING DATA IN INFORMATION PROCESSING APPARATUS

(75) Inventor: Takashi Matsubara, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/559,875

(22) Filed: Sep. 15, 2009

(30) Foreign Application Priority Data
Oct. 24, 2008 (JP) P2008-274720

(51) Int. Cl. G06F 15/16

(52) U.S. Cl. 709/226

(57) ABSTRACT

According to an aspect of the present invention, an information processing apparatus includes: a plurality of media processing resources configured to process media data; a resource selection table indicating suitability in processing of the media data with one of the media processing resources according to an attribute of the media data and a type of the one of media processing resources; and a media processing controller configured to select one of the media processing resources suitable for processing the media data by referring to the resource selection table so that the selected media processing resource processes the media data.

### CROSS-REFERENCE TO RELATED APPLICATIONS

This application is based upon and claims the benefit of priority from Japanese Patent Application No. 2008-274720, filed Oct. 24, 2008, the entire contents of which are incorporated herein by reference.

### BACKGROUND

1. Field

The present invention relates to an information processing apparatus and, more particularly, to processing of allocating a proper resource to media processing.

2. Description of the Related Art

In image processing apparatus which have plural resources and perform media processing such as image processing, processing of allocating one of the resources to each of plural pieces of media processing is known. For example, a resource is allocated to certain processing preferentially (refer to JP-A-2006-94516 (paragraphs 0007-0013 and 0024, FIGS. 1-3 and 11), for example).

However, the method disclosed in JP-A-2006-94516 has a disadvantage that it is unclear how to allocate the resources to use them efficiently in an apparatus in which one of plural kinds of resources is allocated to each of plural kinds of media processing, such as a mobile communication apparatus incorporating multiple functions. This results in a probability that media processing takes long time to cause the user of the apparatus feel inconvenient.

### SUMMARY OF THE INVENTION

According to an aspect of the present invention, there is provided According to an aspect of the present invention, an information processing apparatus includes: a plurality of media processing resources configured to process media data; a resource selection table indicating suitability in processing of the media data with one of the media processing resources according to an attribute of the media data and a type of the one of media processing resources; and a media processing controller configured to select one of the media processing resources suitable for processing the media data by referring to the resource selection table so that the selected media processing resource processes the media data.

### BRIEF DESCRIPTION OF THE SEVERAL VIEWS OF THE DRAWINGS

FIG. 1 is a block diagram showing the configuration of a mobile communication apparatus according to an embodiment of the present invention.

FIG. 2 is a block diagram showing the configuration of a multimedia processing section according to the embodiment.

FIG. 3 shows an example of a color format resource correspondence used in the embodiment.

FIG. 4 shows a comparative example of the color format resource correspondence used in the embodiment.

FIG. 5 shows example resource evaluations for encoding used in the embodiment.

FIG. 6 shows an example of an optimum resource selection table for encoding used in the embodiment.

FIG. 7 shows an example resource use status table used in the embodiment.

FIG. 8 is a flowchart of an encoding process of a still image control section according to the embodiment.

FIG. 9 is a flowchart of step S107 of the process of FIG. 8.

FIG. 10 is a sequence diagram of an example encoding operation (first example operation) in the embodiment.

FIG. 11 is a sequence diagram of a comparative example encoding operation for comparison with the first example operation.

FIG. 12 is a sequence diagram of an example operation (second example operation) in the embodiment in which a decoding operation and an encoding operation are performed in parallel.

FIG. 13 is a sequence diagram of an example encoding operation (third example operation) in the embodiment.

FIG. 14 is a sequence diagram of a comparative example encoding operation for comparison with the third example operation.

FIG. 15 shows an example of the optimum resource selection table for decoding used in the embodiment.

FIG. 16 is a sequence diagram of an example decoding operation in the embodiment.

FIG. 17 is a sequence diagram of an operation in which a still image having a large image size is edited into a still image having a small image size in the embodiment.

FIG. 18 is a sequence diagram of an operation of encoding an original image and its thumbnail image in parallel in the embodiment.

FIG. 19 is a sequence diagram of an operation that an encoding operation is performed while a musical content is reproduced.

### DETAILED DESCRIPTION

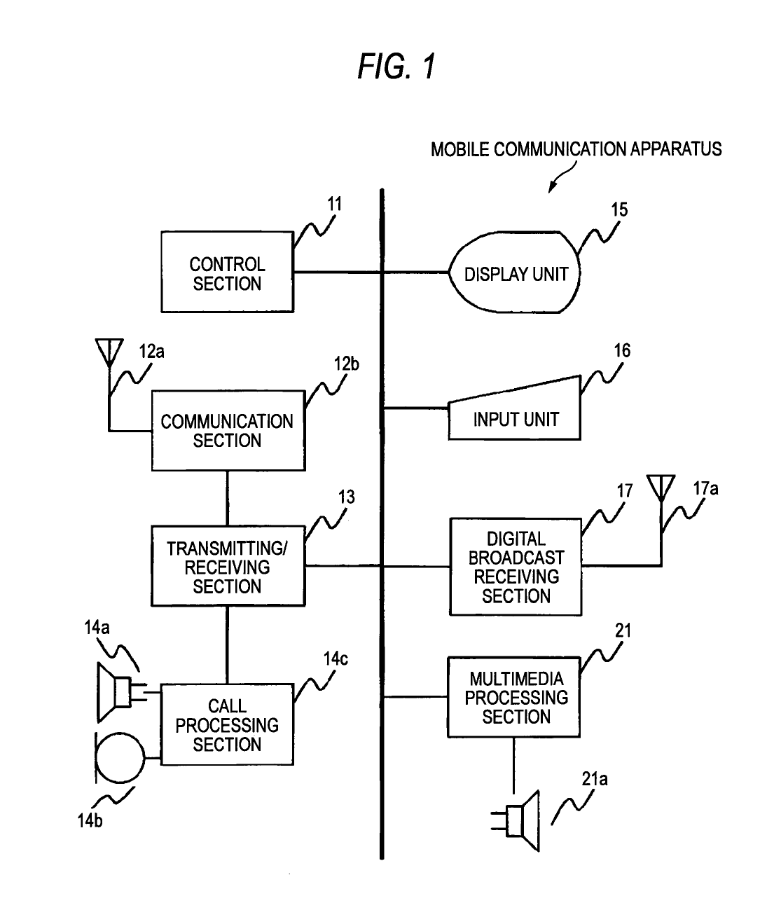

An information processing apparatus according to an embodiment of the present invention will be hereinafter described with reference to the drawings. FIG. 1 is a block diagram showing the configuration of the information processing apparatus, more specifically, a mobile communication apparatus, according to the embodiment of the invention.

The mobile communication apparatus, which is an apparatus for performing a communication over a mobile communication network (not shown), is equipped with a control section 11 for controlling the entire apparatus, an antenna 12a for transmission and reception of radio waves to and from a base station (not shown), a communication section 12b, a transmitting/receiving section 13, a speaker 14a for generation of a received voice, a microphone 14b for input of a voice to be transmitted, a call processing section 14c, a display unit 15, an input unit 16, a digital broadcast receiving section 17, an antenna 17a for receiving radio waves transmitted from digital broadcasting stations, a multimedia processing section 21, and speakers 21a for generating sound reproduced by the multimedia processing section 21.

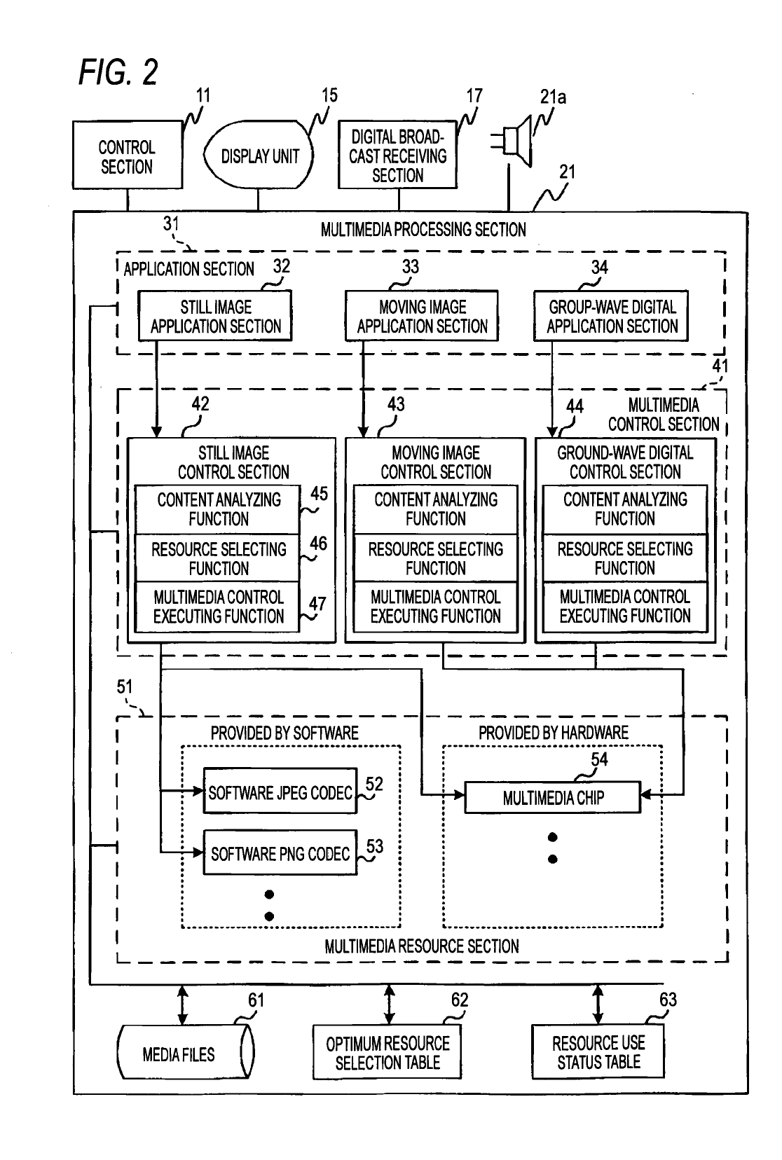

FIG. 2 is a block diagram showing the configuration of the multimedia processing section 21. The multimedia processing section 21, which is connected to the control section 11, is composed of an application section 31 which is a high layer of software processing by a CPU (not shown), a multimedia control section 41 which is a middle layer of the software processing by the CPU and performs controls that particularly relate to the invention, a multimedia resource section 51 which is a lower layer, media files 61, an optimum resource selection table 62, a resource use status table 63, etc.

The high-layer application section 31 has plural application sections, that is, a still image application section 32, a moving image application section 33, a ground-wave digital application section 34 which is connected to the digital broadcast receiving section 17, and other sections.

The middle-layer multimedia control section 41 has plural control sections for controlling one or plural kinds of processing for one or plural media, respectively, that is, a still image control section 42, a moving image control section 43, a ground-wave digital control section 44, etc. The still image control section 42 has a content analyzing function 45, a resource selecting function 46, and a multimedia control executing function 47. Likewise, each of the moving image control section 43 and the ground-wave digital control section 44 has a content analyzing function, a resource selecting function, and a multimedia control executing function.

The lower-layer multimedia resource section 51 generally includes a function part that is provided by software whose functions are realized by CPU processing and a function part that is provided by hardware (e.g., DSP) rather than CPU processing. For example, the function part that is provided by software includes a software JPEG codec 52, a software PNG codec 53, etc., and the function part that is provided by hardware includes a multimedia chip 54, etc.

The media files 61 are files of contents (media data) such as still image files, moving image files, and audio files. Each of the optimum resource selection table 62 and the resource use status table 63 is information that is used for each section of the multimedia control section 41 to select a resource that is most suitable for processing that corresponds to a request from the application section 31 from the resources of the multimedia resource section 51.

How the individual sections of the above-configured mobile communication apparatus according to the embodiment of the invention operate will be described below with reference to FIGS. 1 and 2. The communication section 12b outputs a high-frequency signal received by the antenna 12a to the transmitting/receiving section 13 and causes a high-frequency signal that is output from the transmitting/receiving section 13 to be sent out from the antenna 12a.

The transmitting/receiving section 13 produces a digital signal by performing amplification, frequency conversion, and demodulation on a high-frequency signal supplied from the communication section 12b, and supplies the produced call audio signal and a control signal to the call processing section 14c and the control section 11, respectively.

Furthermore, the transmitting/receiving section 13 produces a high-frequency signal by performing modulation, frequency conversion, and amplification on a digital signal, that is, a call audio signal, that is output from the call processing section 14c and a control signal that is output from the control section 11, supplies it to the communication section 12b, and causes the communication section 12b to send it out.

The call processing section 14c converts a digital audio signal that is output from the transmitting/receiving section 13 into an analog signal, amplifies it, and supplies the amplified signal to the speaker 14a. Furthermore, the call processing section 14c amplifies an analog audio signal that is output from the microphone 14b, converts the amplified signal into a digital audio signal, and supplies it to the transmitting/receiving section 13.

The display unit 15, which is an LCD, for example, displays characters/numerals or video data being controlled by the control section 11. Display data is switched when the display unit 15 receives an instruction from the control section 11 in response to a call termination signal or an input manipulation made through the input unit 16.

The input unit 16 is provided with keys that include plural function keys and character/numeral keys to be used for specifying a telephone number, for example, of a communication partner and inputting characters/numerals. When a key(s) of the input unit 16 is manipulated, the control section 11 is notified of the identifier(s) of the manipulated key(s) and a character(s)/numeral(s) is displayed on the display unit 15 or a control is performed by the control section 11 or a section that receives the key identifier(s) from the control section 11.

The digital broadcast receiving section 17 selects a signal on a channel having a channel number specified by the control section 11 from high-frequency signals of terrestrial digital broadcasts received by the antenna 17a, converts the selected high-frequency signal into an intermediate frequency signal, and demodulates it. The digital broadcast receiving section 17 thus produces a digital broadcast signal and supplies it to the ground-wave digital application section 34.

Next, the functions of the individual sections of the multimedia processing section 21 will be described. The still image application section 32 performs still image processing such as photographing and reproduction, editing, and management of still image data. Where a still image should be displayed in connection with such processing, the still image application section 32 causes the display unit 15 to display it.

The moving image application section 33 performs moving image processing such as video shooting and editing and management of moving image data. Where an image should be displayed in connection with such processing, the moving image application section 33 causes the display unit 15 to display it. Where audio should be output, the moving image application section 33 causes the speakers 21a to generate it. The ground-wave digital application section 34 causes the display unit 15 and the speakers 21a to display a video signal and generate audio of a digital broadcast that are supplied from the digital broadcast receiving section 17.

How the still image control section 42, the moving image control section 43, the ground-wave digital control section 44, etc. operate will be described later in detail.

The software JPEG codec 52 is a codec that is dedicated to compression/expansion processing (i.e., encoding and decoding) of the JPEG, which is one still image data compression method. The software PNG codec 53 is a codec that is dedicated to compression/expansion processing of the PNG, which is another still image data compression method.

The multimedia chip 54 has plural kinds of codec functions such as functions of a still image JPEG codec and a moving image MPEG4 codec and/or H264 codec, and performs encoding or decoding at a time using one of those functions.

The media files 61 are files of contents (media data) that are compressed according to various compression (coding) methods or not compressed and include still image content files, moving image content files, etc. The term “moving image content” means not only a content consisting of a moving image and audio but also a content not having audio and a content having only audio. Each of the media files 61 is a file of information generated by a section of the multimedia processing section 21, a signal received by the transmitting/receiving section 13, a still image signal produced by a camera (not shown), an audio signal that is input through the microphone 14b.

Next, the optimum resource selection table 62 and the resource use status table 63 will be described. Many of the pieces of information contained in each of the tables 62 and 63 are set by a designer of the multimedia processing section 21 and are not updated during operation of the multimedia processing section 21. Therefore, first, based on what characteristics of the individual sections of the multimedia processing section 21 those pieces of information are set by the designer will be described. The following description will be directed to an example that is still image encoding.

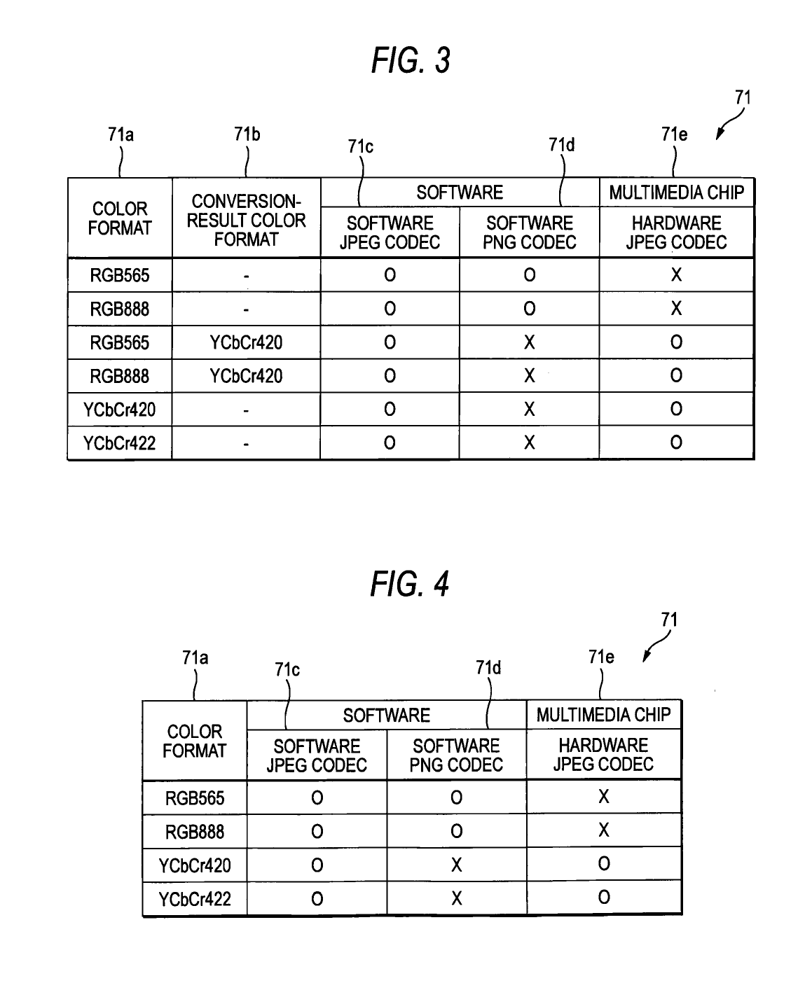

FIG. 3 shows an example of a color format resource correspondence 71 which indicates signals of what color formats the functions of the multimedia resource section 51 (i.e., software JPEG codec 52, software PNG codec 53, and multimedia chip 54) can encode, respectively.

In the color format resource correspondence 71, color formats and conversion-result color formats are correlated with the software JPEG codec 52, the software PNG codec 53, and the multimedia chip 54. If the software JPEG codec 52, the software PNG codec 53, or the multimedia chip 54 can encode a still image having a color format entered in a color format column 71a without any conversion, a mark “−” is entered in the corresponding box of a conversion-result color format column 71b and a mark “∘” is entered in the corresponding box of a software JPEG codec column 71c, a software PNG codec column 71d, or a multimedia chip column 71e.

If the software JPEG codec 52, the software PNG codec 53, or the multimedia chip 54 can encode a still image having a color format entered in the color format column 71a after a conversion, a conversion-result color format is entered in the corresponding box of the conversion-result color format column 71b and a mark “∘” is entered in the corresponding box of the software JPEG codec column 71c, the software PNG codec column 71d, or the multimedia chip column 71e. In the other case, a mark “×” is entered in the corresponding box of the software JPEG codec column 71c, the software PNG codec column 71d, or the multimedia chip column 71e.

More specifically, a still image having a color format “RGB565” or “RGB888” can be encoded by each of the software JPEG codec 52 and the software PNG codec 53 without any conversion. And a still image having the color format “RGB 565” or “RGB888” can be encoded by each of the software JPEG codec 52 and the multimedia chip 54 after a conversion into a still image having a format “YCbCr420.”

A still image having the color format “YCbCr420” or a color format “YCbCr422” can be encoded by each of the software JPEG codec 52 and the multimedia chip 54 without any conversion. The software JPEG codec 52 can encode a still image having any of the color formats “RGB565,” “RGB888,” and “YCbCr420.” This is because the software JPEG codec 52 encodes a signal having the color format “RGB565” or “RGB888” after converting it into a signal having the color format “YCbCr420.”

FIG. 4 shows a comparative example of the color format resource correspondence 71 which does not employ the concept of color format conversion. This comparative example consists of only the table elements in each of which the mark “−” is entered in the box of the conversion-result color format column 71b of the color format resource correspondence 71 of FIG. 3. As a result, a still image having the color format “RGB565” or “RGB888” cannot be encoded by the multimedia chip 54. The utilization of the resources is thus restricted.

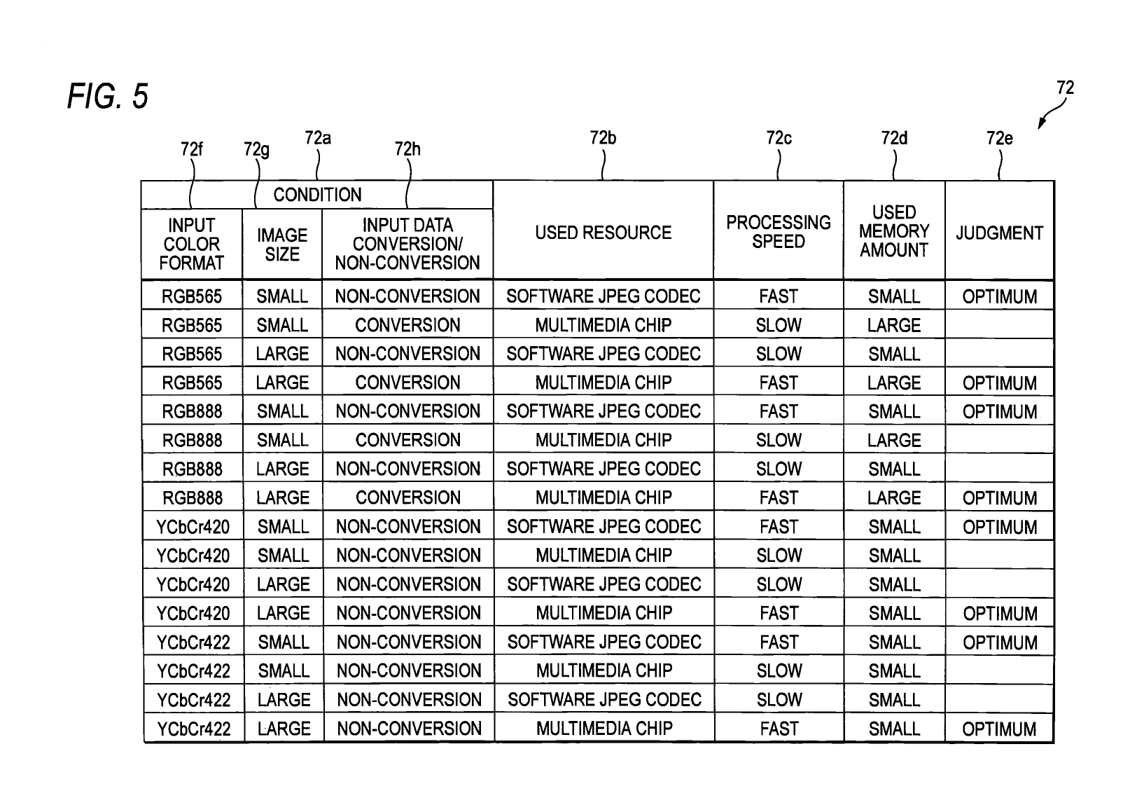

FIG. 5 shows example resource evaluations 72 for still image JPEG encoding. The resource evaluations 72 consist of a condition column 62a, a used resource column 72b, a processing speed column 72c, a used memory amount column 72d, and a judgment column 72e. The condition column 62a consists of an input color format column 72f, an image size column 72g, and an input data conversion/non-conversion column 72h.

The input color format column 72f corresponds to the color format column 71a of the color format resource correspondence 71. The image size column 72g, which relates to the size of a still image to be encoded, has entries “small” and “large.” The used resource column 72b has entries “software JPEG codec” and “multimedia chip” which can encode a still image into a JPEG image.

Each entry of the input data conversion/non-conversion column 72h depends on the corresponding input color format and used resource, and is “conversion” (input data needs to be converted) or “non-conversion” (input data need not be converted). These entries are determined by referring to the color format resource correspondence 71.

A processing speed is evaluated for each combination of all condition items and a used resource, whereby “fast” or “slow” is entered in each box of the processing speed column 72c. A memory amount is evaluated for each combination of all condition items and a used resource, whereby “small” or “large” is entered in each box of the used memory amount column 72d. For pieces of still image JPEG encoding processing that are the same in input color format and image size, a used resource that provides best total performance is given an entry “optimum” in the corresponding box of the judgment column 72e and the other used resource is given no entry in the corresponding box of the judgment column 72e.

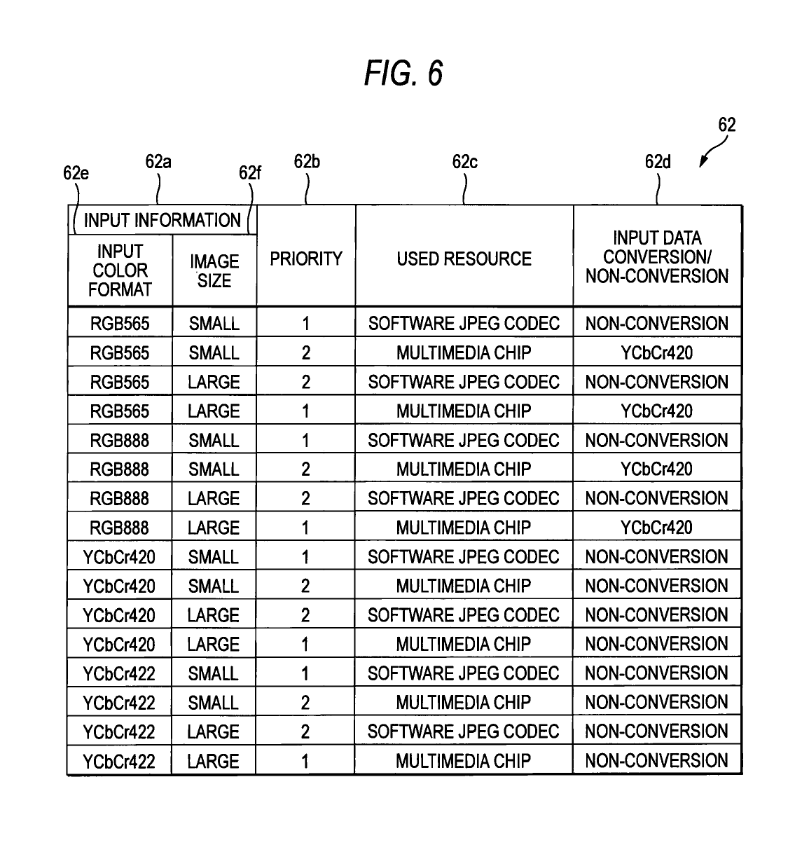

FIG. 6 shows an example of the optimum resource selection table 62 for still image JPEG encoding. The optimum resource selection table 62 is generated on the basis of the color format resource correspondence 71 and the resource evaluations 72 and is information to be referred to when the multimedia processing section 21 operates. The optimum resource selection table 62 consists of an input information column 62a, a priority column 62b, a used resource column 62c, and an input data conversion/non-conversion column 62d. The input information column 62a consists of an input color format column 62e and an image size column 62f.

The input color format column 62e, the image size column 62f, and the used resource column 62c correspond to the input color format column 72f, the image size column 72g, and the used resource column 72b of the resource evaluations 72, respectively. The input data conversion/non-conversion column 62d corresponds to the input data conversion/non-conversion column 72h of the resource evaluations 72 except that the conversion-result color format “YCbCr420” is entered instead of “conversion.”

Priority is evaluated for each combination of an input color format, an image size, and a used resource. For pieces of still image JPEG encoding processing that are the same in input color format and image size, a used resource that provides best performance is given an entry “1” in the corresponding box of the priority column 62b and a used resource that provides second best performance is given an entry “2” in the corresponding box of the priority column 62b. The priority column 62b corresponds to the judgment column 72e of the resource evaluations 72.

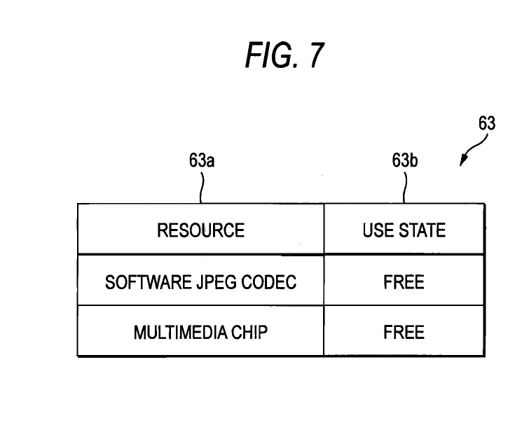

FIG. 7 shows an example of that part of the resource use status table 63 which relates to still image JPEG encoding. The table of FIG. 7 consists of a resource column 63a and a use status column 63b. The resource column 63a has entries “software JPEG codec” and “multimedia chip.” The use status column 63b has entries “free” and “in use,” one of which is entered dynamically during operation of the multimedia processing section 21. The resource use status table 63 thus indicates whether each of the software JPEG codec 52 and the multimedia chip 54 is in operation or not.

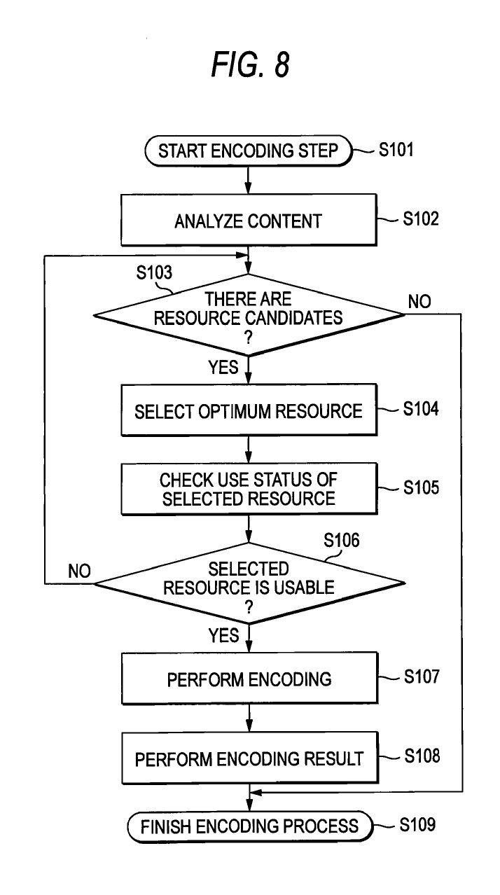

Next, how the still image control section 42, the moving image control section 43, the ground-wave digital control section 44, etc. operate will be described for an example case that the still image control section 42 encodes a still image into a JPEG image. FIG. 8 is a flowchart of a process of this case. At step S101, the still image control section 42 starts to operate in response to a request from the still image application section 32. At this time, a media file 61 of a still image content to be encoded is specified.

At step S102, the still image control section 42 analyzes the specified content and thereby recognizes its color format and size (large or small). Step S102 is executed by the content analyzing function 45.

At step S103, the still image control section 42 judges whether the multimedia processing section 21 has a resource for encoding the specified content by searching the optimum resource selection table 62 for table elements having the color format and the size recognized by the analysis of the content as an input color format entry and an image size entry, respectively.

If the multimedia processing section 21 has resources for encoding the specified content, that is, if resource candidates have been found by the search, at step S104 the still image control section 42 selects an optimum resource to be used, that is, a resource having the priority rank “1.” The still image control section 42 acquires information indicating whether the selected resource is in use or not by referring to the use status column 63b of the resource use status table 63 at step S105, and judges whether it is usable at step S106.

If the selected resource is usable, that is, if the entry in the corresponding box of the use status column 63b is “free,” the still image control section 42 encodes the content using the selected resource at step S107, outputs an encoding result to the media file 61 at step S108, and finishes the encoding process at step S109. The encoding step (step S107) will be described later in detail. Steps S103-S106 are executed by the resource selecting function 46 and step S107 (encoding step) is executed by the multimedia control executing function 47.

If it is judged at step S106 that the selected resource is not usable, that is, if the entry in the corresponding box of the use status column 63b is “in use,” the process returns to step S103 (whether the multimedia processing section 21 has resource candidates is judged). This judgment is made in such a manner that the resource candidate for which “in use” is entered in the corresponding box of the use status column 63b is excluded. Is it is judged at step S107 that the multimedia processing section 21 has no resource candidate, at step S109 the still image control section 42 finishes the encoding process.

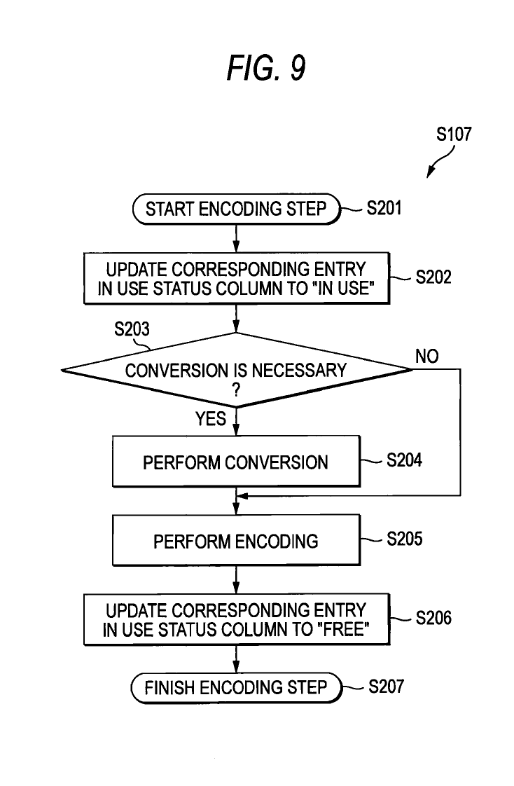

The encoding step (S107) will be described below in detail with reference to a flowchart of FIG. 9. At step S201, the still image control section 42 starts the encoding step. At step S202, the still image control section 42 updates, to “in use,” the entry in the use status column 63b that is correlated with the entry “software JPEG codec” or “multimedia chip” in the resource column 63a depending on whether the resource to be used is the software JPEG codec 52 or the multimedia chip 54.

At step S203, the still image control section 42 judges whether a conversion is necessary by searching the optimum resource selection table 62 using search keys that the entry in the input color format column 62e should be the color format of the content specified at step S101 and the entry in the used resource column 62c should be the resource selected at step S104.

If a conversion is necessary, that is, if a color format is entered in the box found of the input data conversion/non-conversion column 62d, at step S204 the still image control section 42 converts the specified content into a still image having that color format. If no conversion is necessary, that is, if “non-conversion” is entered in the box found of the input data conversion/non-conversion column 62d, at step S205 the still image control section 42 encodes the specified content without converting it. At step S206, the still image control section 42 updates, to “free,” the entry in the use status column 63b that was updated to “in use” at step S202. At step S207, the still image control section 42 finishes the encoding step.

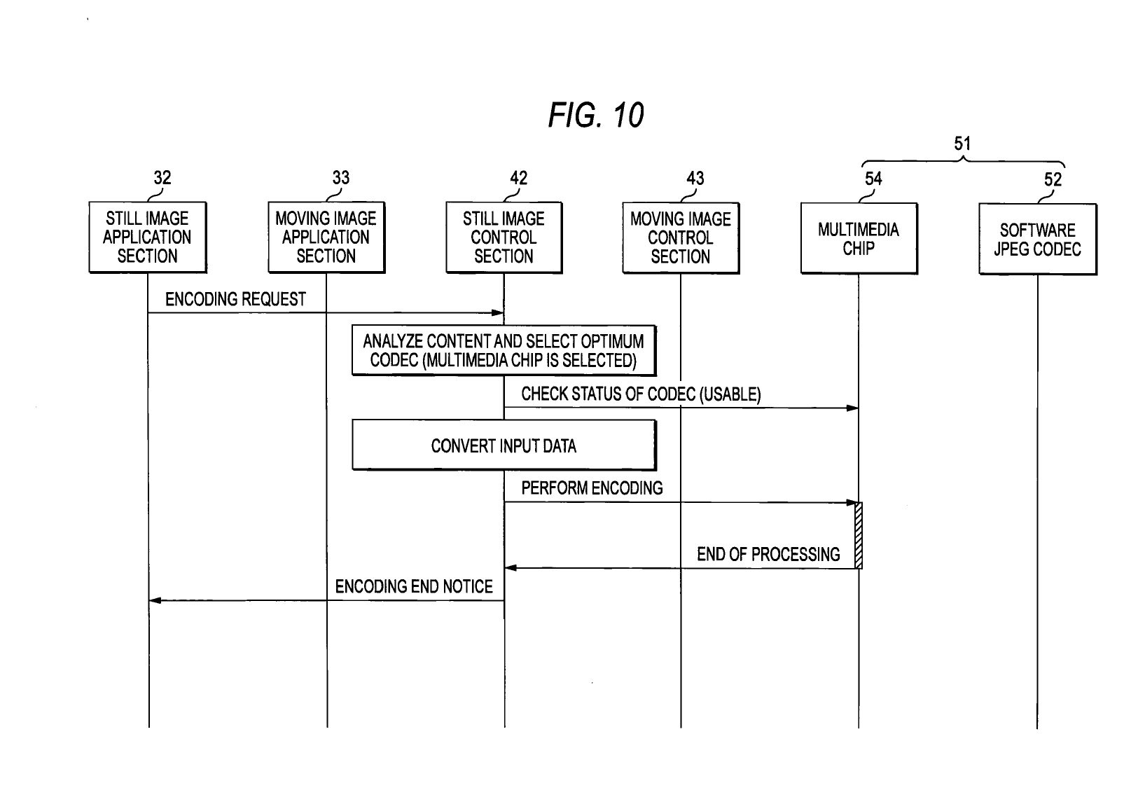

Next, example operations performed by the multimedia processing section 21 will be described. FIG. 10 is a sequence diagram of a first example operation of encoding a media file 61 of a content having the color format “RGB565” and a large size into a JPEG content.

The still image application section 32 requests the still image control section 42 to perform encoding operation. The still image control section 42 judges that it is most appropriate to use the multimedia chip 54 by executing step S104 (see FIG. 8). Since the multimedia chip 54 is usable, the still image control section 42 converts the content by executing step S204 (see FIG. 9) and causes multimedia chip 54 to encode a resulting still image. In this manner, the content can be processed at high speed though it needs to be converted.

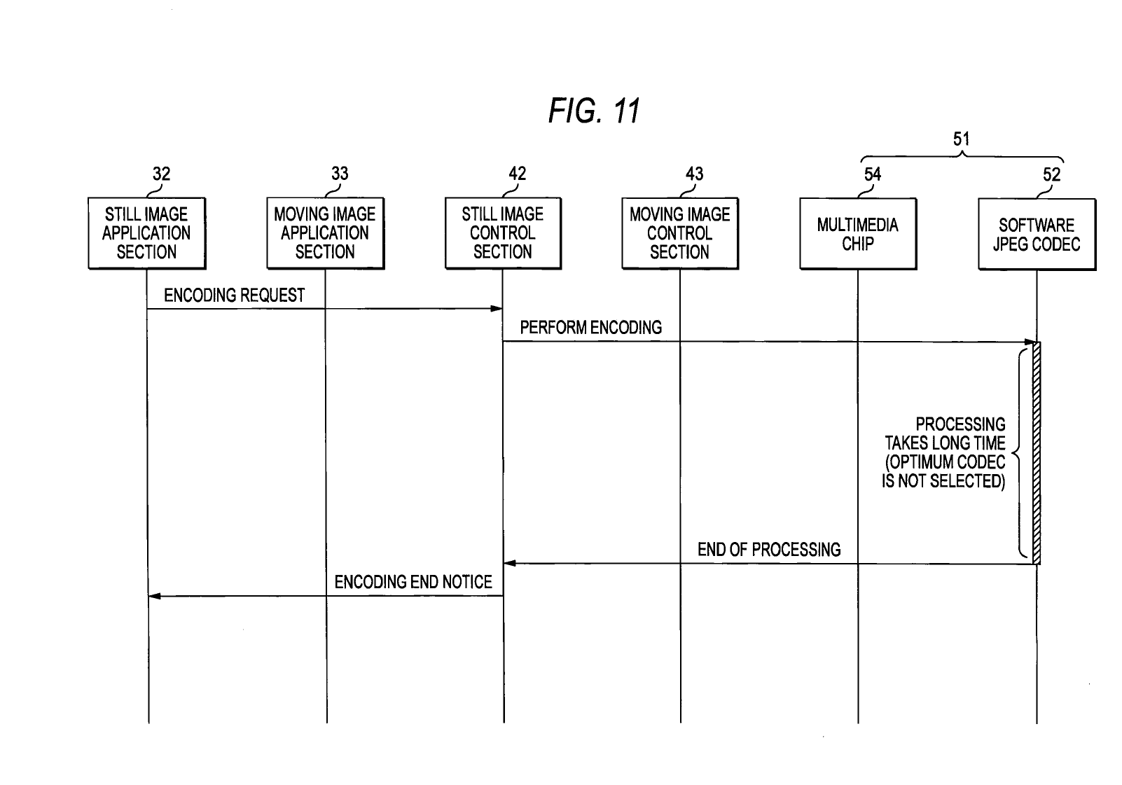

FIG. 11 is a sequence diagram of a comparative example operation which serves for comparison with the above first example operation and corresponds to the comparative example of the color format resource correspondence 71 (see FIG. 4). In this case, no content conversion is performed. It is judged that the content can only be encoded by the software JPEG codec 52. As a result, the still image control section 42 cannot select an optimum resource and the operation takes long time.

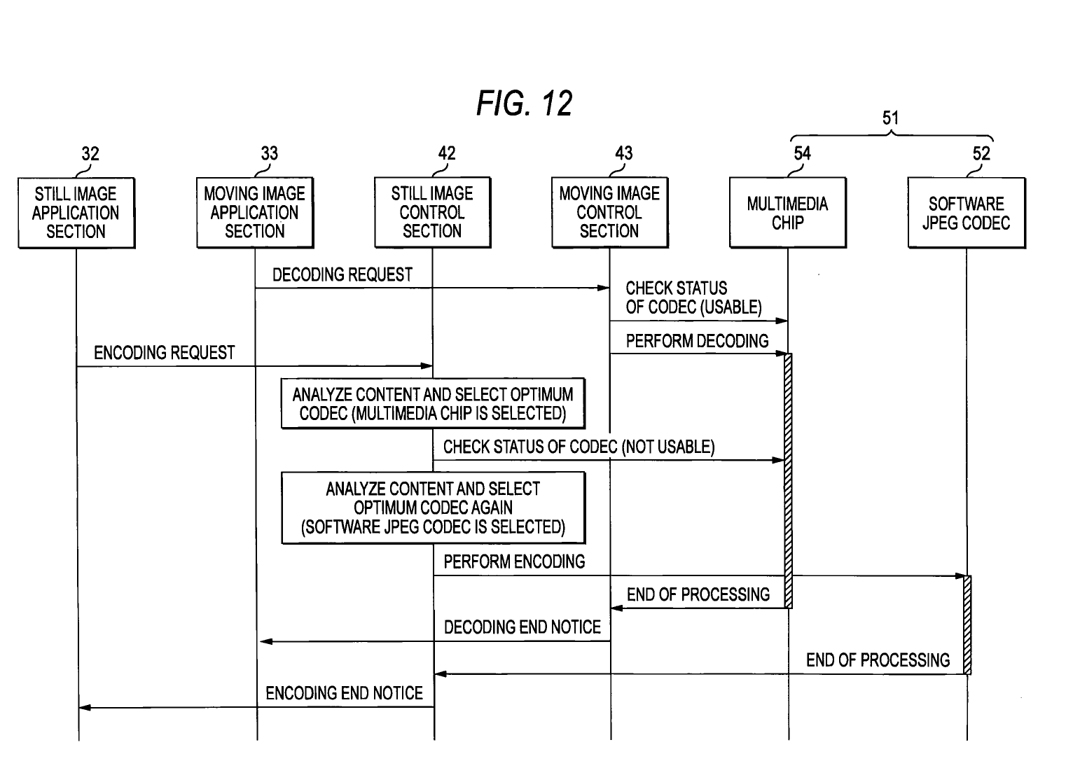

FIG. 12 is a sequence diagram of a second example operation. The moving image application section 33 requests the moving image control section 43 to decode a media file 61 of a moving image content. Capable of using the multimedia chip 54, the moving image control section 43 causes the multimedia chip 54 to decode the content. The same encoding operation as in the above first example operation is started during the decoding.

The still image control section 42 first selects the multimedia chip 54 by executing step S104 (see FIG. 8). However, since the multimedia chip 54 is not usable, the still image control section 42 then selects the software JPEG codec 52 by executing step S104 and causes it to encode the content. In this manner, if a resource that is judged most appropriate is in use, encoding is performed by using a second best resource. Encoding can be started immediately without wasting time waiting until the resource that is currently in use becomes free.

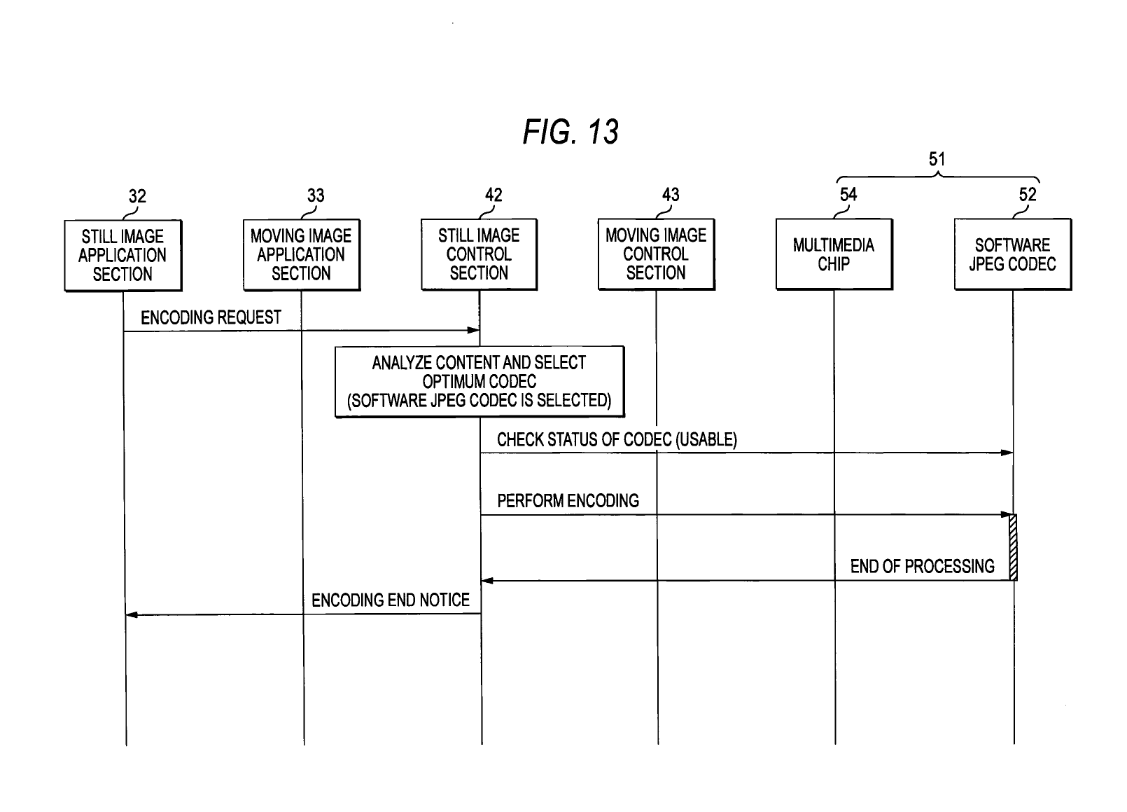

FIG. 13 is a sequence diagram of a third example operation of encoding a media file 61 of a content having the color format “RGB565” and a small size into a JPEG content.

The still image application section 32 requests the still image control section 42 to perform encoding. The still image control section 42 selects the software JPEG codec 52 by executing step S104 (see FIG. 8). Since the software JPEG codec 52 is usable, the still image control section 42 converts the content by executing step S204 (see FIG. 9) and causes the software JPEG codec 52 to encode a resulting still image.

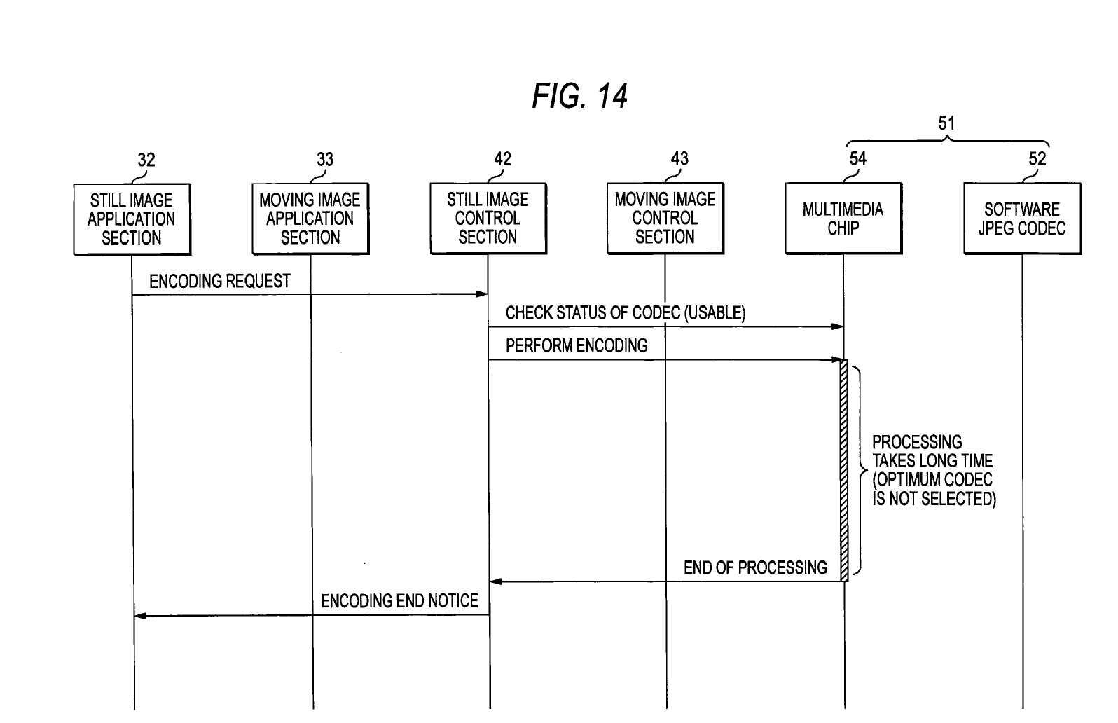

FIG. 14 is a sequence diagram of a comparative example operation which serves for comparison with the above third example operation. In this case, an optimum resource is not selected. That is, the still image control section 42 selects the multimedia chip 54 because its processing speed is higher than the processing speed of the software JPEG codec 52.

The processing speed of the multimedia chip 54 is higher than that of the software JPEG codec 52. However, where the multimedia chip 54 is used, overhead processing times are caused by starting of the multimedia chip 54, reading and ending of firmware, etc. On the other hand, where the software JPEG codec 52 is used, almost no such overhead processing times occur. Therefore, it is not appropriate to select a resource without referring to the size of a content to be encoded. A long processing time may be taken.

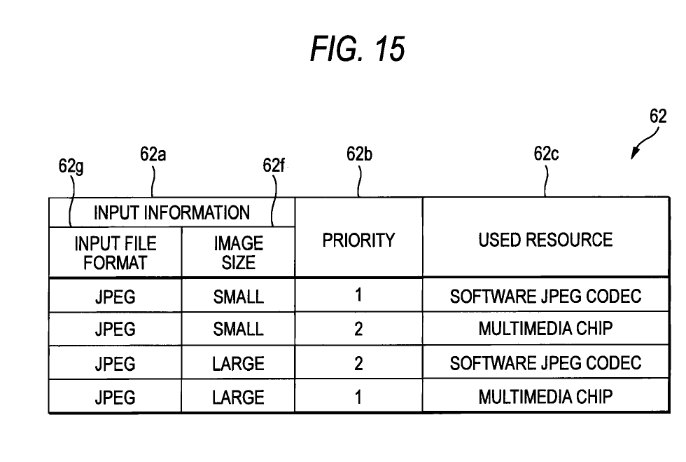

Next, a description will be made of how the decoding process is different from the encoding process. FIG. 15 shows an example of the optimum resource selection table 62 for decoding of a JPEG content. This optimum resource selection table 62 is different from the optimum resource selection table 62 for encoding (see FIG. 6) in that the former does not include the input data conversion/non-conversion column 62d or the input color format column 62e (in the input information column 62a) and includes an input file format column 62g additionally.

The above differences are due to the fact that no color format conversion is performed in a decoding operation. Since this example optimum resource selection table 62 contains information to be used for processing a JPEG content, “JPEG” is entered in each box of the input file format column 62g.

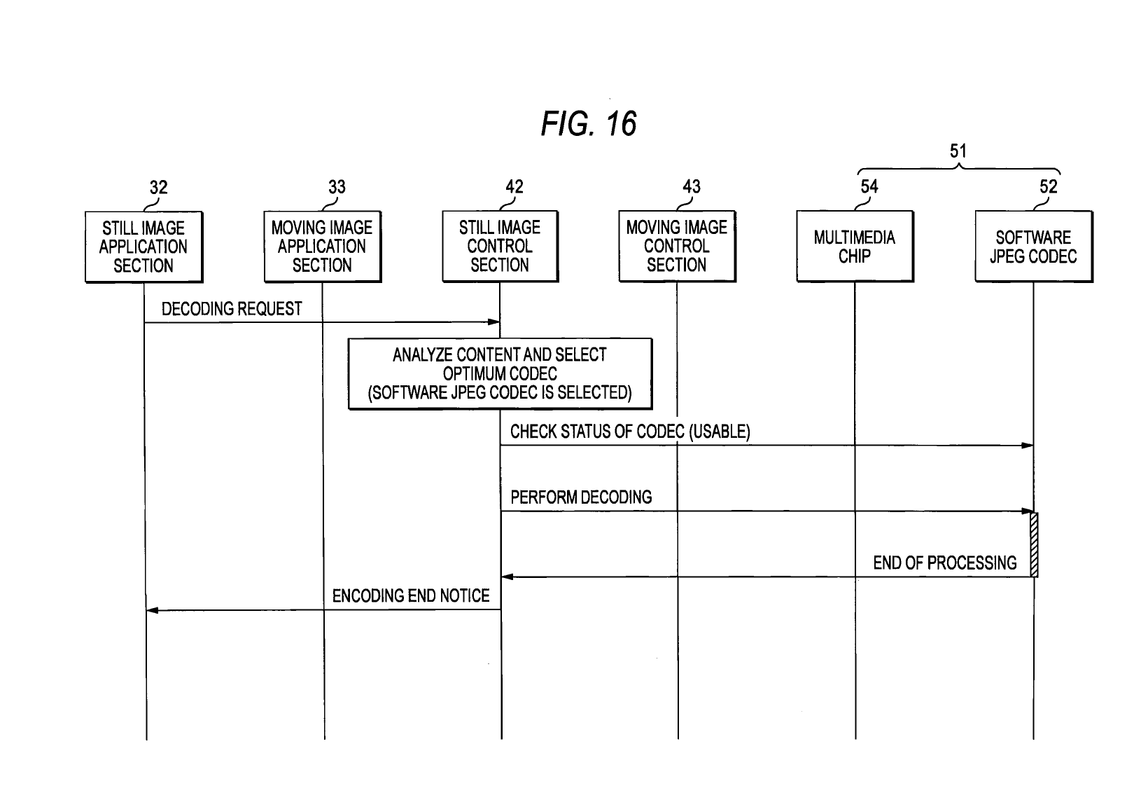

FIG. 16 is a sequence diagram of an example decoding operation which is performed by the multimedia processing section 21. Like the example encoding operation (third example operation) of FIG. 13, this is an example of processing (decoding) a media file 61 of a JPEG content having a small size. The still image control section 42 selects the software JPEG codec 52 according to the optimum resource selection table 62 of FIG. 15.

The above description is mainly directed to such examples that the still image control section 42 selects a resource when the still image application section 32 causes the still image control section 42 to encode a still image into a JPEG image. In the following, specific applications will be described with reference to respective operation sequence diagrams.

First, a description will be made of an operation of editing an encoded JPEG still image, that is, an operation of converting a media file 61 that has a large image size because of a high resolution into a media file 61 having a low resolution and a small image size. For example, this operation is performed to enable or facilitate attachment of the media file 61 to an e-mail. It is assumed that the still image to be edited has the color format “YCbCr420.”

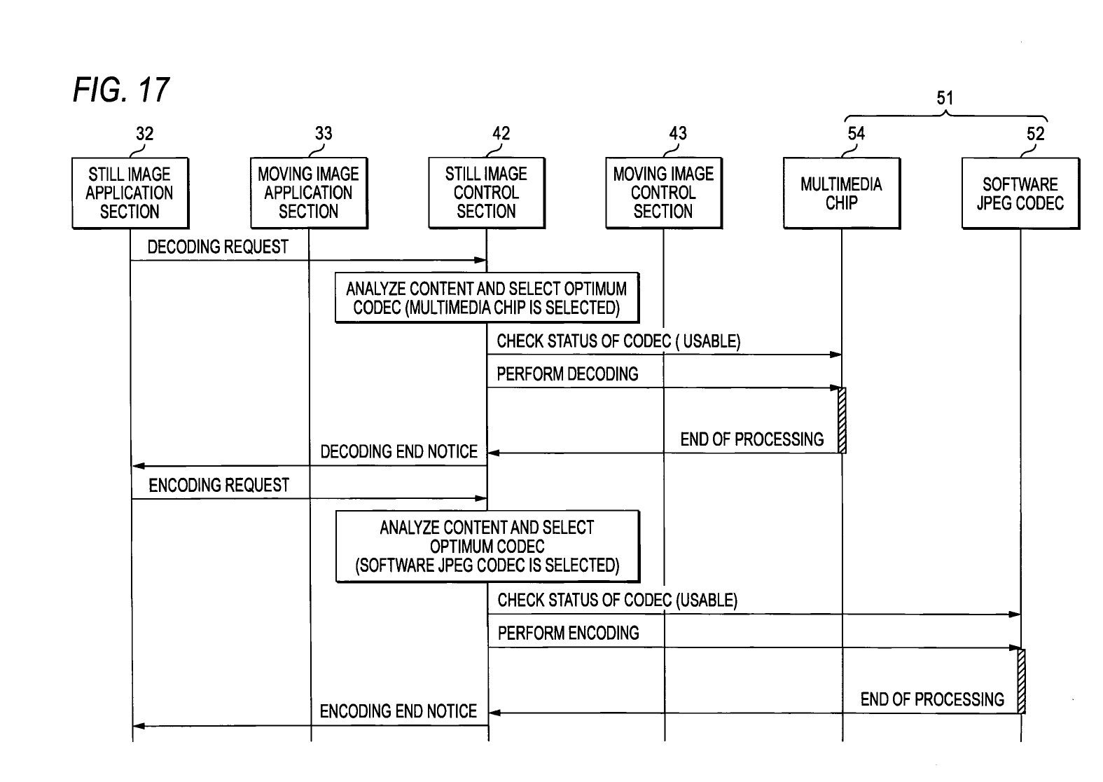

FIG. 17 is a sequence diagram of this operation. First, to decode a still image having a large image size, the still image control section 42 judges that the multimedia chip 54 is an optimum resource and selects it by executing step S104 (see FIG. 8; the optimum resource selection table 62 of FIG. 15 is referred to). Then, to encode a still image having a small image size, the still image control section 42 judges that the software JPEG codec 52 is an optimum resource and selects it by executing step S104 (see FIG. 8; the optimum resource selection table of FIG. 6 is referred to). The resources that are suitable for the respective image sizes are used as a result of these judgments and high-speed processing is thereby enabled.

Although in the above operation the still image application section 32 requests the still image control section 42 to perform two operations, that is, a decoding operation and an encoding operation, the invention is not limited to such a case. The still image application section 32 may request editing of a still image. Also in this case, optimum resources can be selected.

Second, a description will be made of an operation of causing the still image control section 42 to encode an original image and its thumbnail image when the still image application section 32 causes the still image control section 42 to encode the still image into a JPEG image. The original image and its thumbnail image are encoded in parallel by using, for the former, a resource that is suitable for a large image size and using, for the latter, a resource that is suitable for a small image size. High-speed processing is thus possible. It is assumed that the still image to be encoded has the color format “RGB565.”

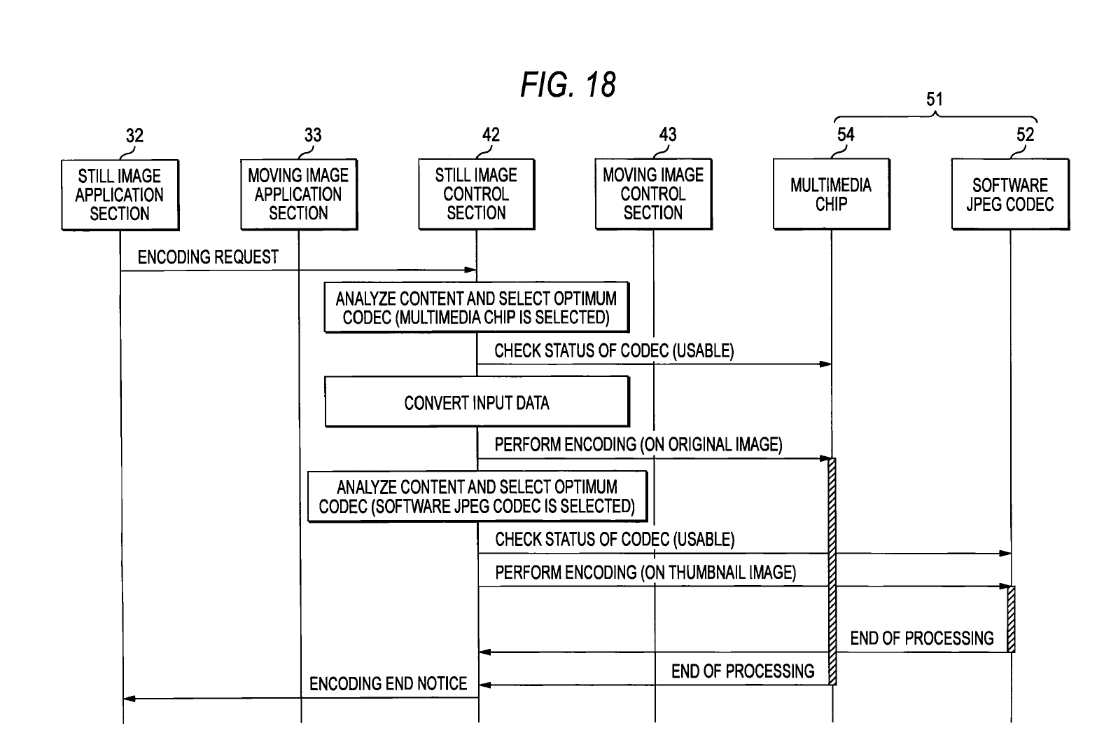

FIG. 18 is a sequence diagram of this operation. Receiving a request for two encoding operations, first, to encode an original image which is a still image having a large image size, the still image control section 42 judges that the use of the multimedia chip 54 is most appropriate and causes the multimedia chip 54 to encode the original image after converting it.

Then, to encode a thumbnail image which is a still image having a small image size, the still image control section 42 judges that the use of the software JPEG codec 52 is most appropriate and causes it to encode the thumbnail image. Irrespective of which encoding operation has been completed first, after completion of the two encoding operations, the still image control section 42 informs the still image application section 32 that the requested encoding operations have been completed.

Each of the above optimum resources is selected by executing step S104 (see FIG. 8) while referring to the optimum resource selection table 62 of FIG. 6. The thumbnail image is not converted because it is encoded by the software JPEG codec 52.

Third, a description will be made of an operation that the still image application section 32 causes the still image control section 42 to encode a still image into a JPEG image while another operation, for example, reception of a digital TV broadcast, reproduction of a moving image, or reproduction of music is performed. The still image can be encoded without finishing the other operation.

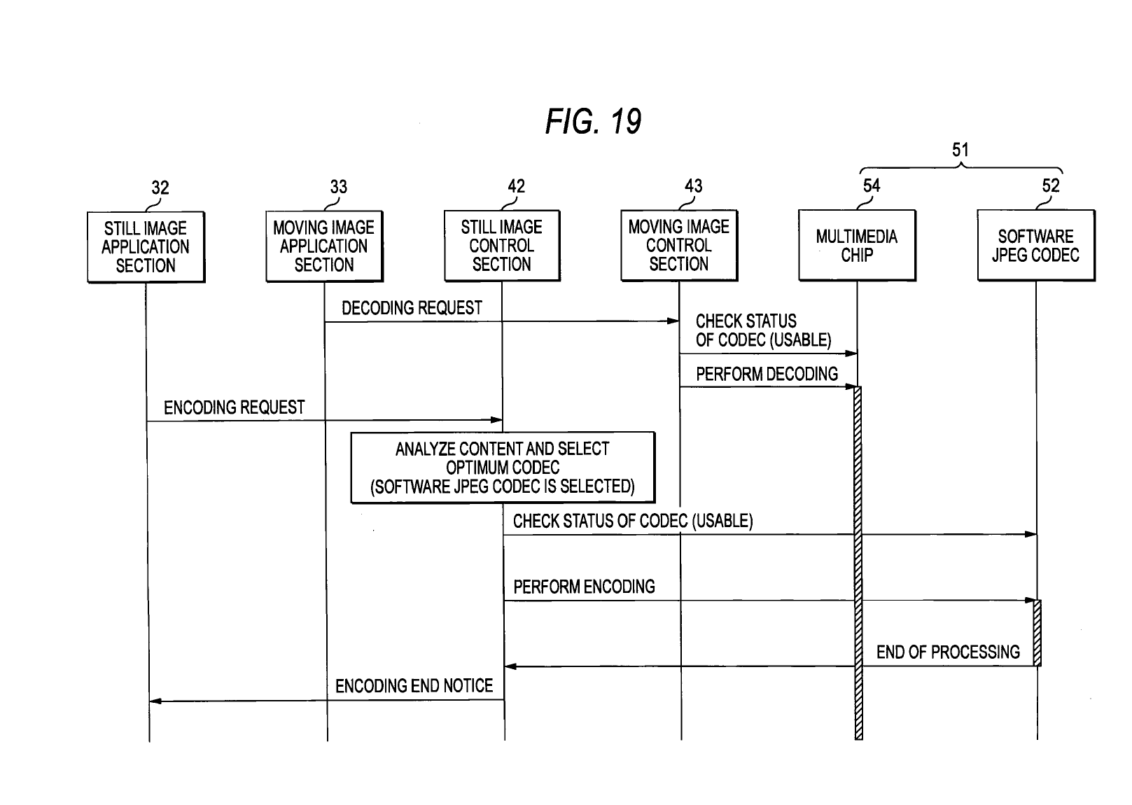

FIG. 19 is a sequence diagram of this operation. The moving image application section 33 requests the moving image control section 43 to decode, that is, reproduce, a media file 61 of a musical content. Capable of using the multimedia chip 54, the moving image control section 42 causes the multimedia chip 54 to reproduce the musical content.

To encode a still image having a small size into a JPEG image during reproduction of the musical content, the still image control section 42 judges that the use of the software JPEG codec 52 is most appropriate by executing step S104 (see FIG. 8; the optimum resource selection table 62 of FIG. 6 is referred to) and causes it to encode the still image. Since the still image is encoded by the software JPEG codec 52, it is not converted irrespective of its color format.

When the size of the still image to be encoded is large, the optimum resource is the multimedia chip 54. However, since the multimedia chip 54 is already in use, the software JPEG codec 52 is selected as a second best resource (see the sequence diagram of FIG. 12). The still image is encoded irrespective of its size during reproduction of music by the moving image control section 43.

In the above description, in the resource evaluations 72, a judgment entry is obtained by evaluating a processing speed and a used memory amount on the basis of attributes of media data to be processed. However, the invention is not limited to such a case. For example, an attribute (e.g., power consumption) of a used resource may be evaluated. Furthermore, an attribute of a component outside the multimedia processing section 21, for example, energy that is stored in a battery for supplying power to the individual sections of the apparatus or a size of a free area of a memory provided in the apparatus, may be evaluated.

In the above description, an input color format and an image size are used as attributes of media data to be processed. However, the invention is not limited to such a case. For example, vertical and horizontal sizes of an image of a media file 61 may be used as attributes.

When a judgment entry is obtained in the resource evaluations 72, an image size is classified as “small” or “large,” a processing speed is evaluated and judged “fast” or “slow,” and a used memory amount is evaluated and judged “small” or “large.” However, each item may be classified into or judged to be one of three or more levels, or may take an integer or a real number. In particular, where three or more resources are available, it is effective to calculate a judgment entry using integers or real numbers.

When the resource evaluations 72 are modified in the above manner, naturally, the optimum resource selection table 62 is modified accordingly. The still image control section 42 selects a resource according to the modified optimum resource selection table 62.

In the above description, information indicating whether each resource is in use or free is entered in the resource use status table 63. However, the invention is not limited to such a case. Each section of the multimedia control section 41 may judge a status of each resource by inquiring of the resource. As a further alternative, resource statuses may be stored as part of OS functions of the control section 11. Each section of the multimedia control section 41 judges a status of each resource by inquiring of the control section 11.

In the above description, though the multimedia chip 54 has various functions, it is assumed that the multimedia chip 54 can perform only one of them at a time (i.e., it cannot perform plural functions simultaneously). However, the invention is not limited to such a case. The multimedia chip 54 may perform plural functions simultaneously. In this case, the condition column 72a of the resource evaluations 72 should include a column “other functions in operation.” As a result, the input information column 62a of the optimum resource selection table 62 should also include a column “other functions in operation.”

Furthermore, the individual functions of the multimedia chip 54 should be entered in the resource column 63a of the resource use status table 63. The same applies to a case that plural tasks of one function part that is provided by software whose functions are realized by CPU processing operate in parallel.

In the above description, once each of the software JPEG codec 52 and the multimedia chip 54 starts a certain operation, it cannot work in such a manner that it suspends that operation, processes another media file 61, finishes its processing, and restarts the suspended operation. Furthermore, a suspended operation cannot be restarted by a resource that is different from a resource that was used before the suspension.

To realize such a suspension and restart, complicated processing is required in the software JPEG codec 52 and the multimedia chip 54. In particular, to restart a suspended operation by a resource that is different from a resource that was used before the suspension, the internal processing procedures and the data structures of these two resources need to be unified, which is an obstruction to optimum, high-speed operation of each resource. Therefore, this is not preferable in apparatus that operate on energy stored in a battery, such as mobile communication apparatus.

In the above description, media processing performed by the multimedia processing section 21 is such that it receives a media file 61 and outputs a resulting media file 61. However, the invention is not limited to such a case. The multimedia processing section 21 may receive data that is received by the transmitting/receiving section 13, and may output data that is sent out by the transmitting/receiving section 13. The multimedia processing section 21 may be such that a decoded image is displayed on the display unit 15 and decoded audio is reproduced by the speakers 21a. The invention is not limited to the above-described configuration and various modifications are possible.

As described with reference to the embodiment, there is provided an information processing apparatus in which a proper one is selected from plural kinds of resources and allocated to each of plural kinds of media processing.

The embodiment makes it possible to select a proper one of plural kinds of resources and allocate it to each of plural kinds of media processing.

What is claimed is:

1. An information processing apparatus comprising:
a plurality of media processing resources configured to process media data;
a resource selection table indicating suitability in processing of the media data with one of the media processing resources according to an attribute of the media data and a type of the one of media processing resources; and
a media processing controller configured to select one of the media processing resources suitable for processing the media data by referring to the resource selection table so that the selected media processing resource processes the media data.

2. The information processing apparatus according to claim 1, wherein the resource selection table including a rank of the suitability with respect to each media processing resources; and
the selected media processing resource has the highest rank of the suitability in the media processing resources that are possible to process the media data.

3. The information processing apparatus according to claim 1, wherein the attribute of the media data include a size of the media data.

4. The information processing apparatus according to claim 1, wherein the resource selection table further indicating suitability in processing of converted media data obtained by converting the media data with one of the media processing resources according to an attribute of the converted media data and a type of the one of media processing resources.

5. The information processing apparatus according to claim 4, wherein the media data is first image data;
the attribute of the media data is a color format;
the converted media data is second image data having, as an attribute, a color format that is changed from the color format of the media data;
the processing of the media data is encoding on the first image data; and
the processing of the converted media data is encoding on the second image data.

6. The information processing apparatus according to claim 1, wherein the media processing resources include a media processing resource that is provided by software and a media processing resource that is provided by hardware dedicated to media processing.

7. The information processing apparatus according to claim 1 further comprising a resource status table indicating each statuses of the media processing resources,
wherein the media processing controller configured to select one of the media processing resources suitable for processing the media data by referring to the resource selection table and the resource status table so that the selected media processing resource process the media data.

8. A method for selecting one of media processing resources comprising:
analyzing media data to determine whether or not the media processing resources include at least one of media processing resources that are possible to process the media data;
selecting one of the media processing resources based on a resource selection table;
checking that a status of the selected media processing resource; and
encoding the media data by the selected media processing resource when the status is enable,
wherein the resource selection table indicating suitability in processing of the media data with one of the media processing resources according to an attribute of the media data and a type of the one of media processing resources.

9. The method according to claim 8, wherein the resource selection table including a rank of the suitability with respect to each media processing resources; and
the selected media processing resource has the highest rank of the suitability in the media processing resources that are possible to process the media data.

10. The method according to claim 9 further comprising re-selecting the other of the media processing resources for encoding when the status of the selected media processing resource is disable,
wherein the re-selected media processing resources has second highest rank of the suitability in the media processing resources that are possible to process the media data.
